(19) United States
(12) Patent Application Publication
(10) Pub. No.: US 2021/0313849 A1
(43) Pub. Date: Oct. 7, 2021

(54) ELECTRIC MOTOR COMPRISING AN INTEGRALLY FORMED INNER ROTOR CORE

(71) Applicant: Nidec Corporation, Kyoto (JP)

(72) Inventors: Pascual GUARDIOLA, Ingersheim (DE); Uwe LASEBNICK, Stuttgart (DE)

(21) Appl. No.: 17/259,801

(22) PCT Filed: Jul. 12, 2019
(86) PCT No.: PCT/IB2019/055947

§ 371 Date: Jan. 12, 2021

(30) Foreign Application Priority Data
Jul. 13, 2018 (DE) 10 2018 116 988.4

(51) Int. Cl. H02K 1/27; H02K 1/28; H02K 21/14; H02K 15/03; B21C 23/00

(52) U.S. Cl. CPC H02K 1/276; H02K 1/28; B21C 23/002; H02K 15/03; H02K 21/14

(57) ABSTRACT

An integrally molded internal rotor core of a brushless electric motor includes a central bore, and the rotor core is manufactured by a cold extrusion process.

### CROSS REFERENCE TO RELATED APPLICATIONS

This is a U.S. national stage of PCT Application No. PCT/IB2019/055947, filed on Jul. 12, 2019, with priority under 35 U.S.C. § 119(a) and 35 U.S.C. § 365(b) being claimed from German Application No. 102018116988.4, filed Jul. 13, 2018; the entire disclosures of which are hereby incorporated herein by reference.

### FIELD OF THE INVENTION

The present invention relates to a rotor core of a brushless electric motor, a rotor assembly of a brushless electric motor, and a brushless electric motor and a method of manufacturing a rotor core.

### BACKGROUND

Prior art electric motors are known in which the rotor carries permanent magnets. The permanent magnets are arranged around a rotor core and sit on its outside. The rotor defines the geometrical axes and directions. A central axis coincides with the axis of symmetry of the rotor and also represents the axis of rotation of the rotor in the electric motor. The axial direction of the arrangement is in the direction of the axis of rotation. The radial direction is characterized by increasing distance from the central axis. The permanent magnets of the rotor are therefore located on the outside in the radial direction. Tangential to the rotor is the circumferential direction, where each direction vector is perpendicular to a radius of the arrangement.

According to the prior art, the electric motor also has a stator arranged radially outside the rotor, which surrounds the rotor on the outside in a ring shape. The stator contains a number of electromagnets, which are generally formed by an iron core and a winding. A suitable current supply to the stator windings generates a rotating field, which in turn generates a torque in the rotor. The stator is located in a motor housing in which the rotor with its motor shaft is rotatably mounted.

Traditionally, the rotor core is assembled from a large number of sheets of essentially the same cross-section. These sheets are laminated to form a lamella package, which forms the rotor core.

It is also known to form massive internal rotor cores. Document DE 10 2014 202 572 A1 reveals such a core cast from steel.

### SUMMARY

Example preferred embodiments of the present disclosure provide rotor cores, rotor assemblies, and electric motors in each of which a rotor core is particularly easy and inexpensive to manufacture.

An internal rotor core of a brushless electric motor according to a preferred embodiment of the present disclosure includes a central bore, has a one piece unitary structure, and is manufactured by cold extrusion. The rotor core can thus be produced at ambient temperature in the desired shape in large quantities at low cost. The rotor core is preferably made of a soft steel with a high iron content.

In an example preferred embodiment of the present disclosure, the rotor core includes flat outer surfaces, each of the same size and shape, distributed at uniform or substantially uniform angular intervals along the outer peripheral surface of the rotor core, with a groove provided between each pair of adjacent outer surfaces, which groove extends from the outside in the radial direction in the edge defined by the pair of adjacent outer surfaces. Preferably, the groove is open radially outwards and extend parallel or substantially parallel to a central axis of the rotor core. In particular, the groove preferably has a rectangular or substantially rectangular cross-section. It is advantageous if a total of eight outer surfaces are provided on the outside of the rotor, for example.

Preferably, recesses are provided at one end of the rotor core in the axial direction to accommodate magnetic holders. These recesses are preferably T-shaped in the radial direction and open at the top in axial direction. It is also advantageous if the recesses have a constant or substantially constant depth in the axial direction, such that the depth only takes up a small portion of the total length of the rotor core in the axial direction, in particular less than about 20%, and preferably less than about 10%. The recesses can thus be inserted particularly easily during the manufacturing of the rotor core (cold extrusion process).

Preferably, the recesses in the circumferential direction are located in the area of the edges between two adjacent outer surfaces.

The rotor core is preferably pot-shaped and includes a bottom which is pierced by the central bore. The inner diameter of the central bore is smaller than the inner diameter of the rotor in the area of the pot (inner diameter of the rotor shell). The rotor core is therefore much lighter and cheaper than conventional rotor cores, because some of the material is omitted. This structure can be easily formed via the cold extrusion process.

In an example preferred embodiment, a rotor assembly of a brushless electric motor further includes a rotor core of an internal rotor surrounding a central axis, a plurality of permanent magnets positioned around the rotor core in a circumferential direction of the rotor assembly, each including a flat outer contact surface, a flat inner contact surface, two axial end surfaces and two side surfaces, the flat inner contact surfaces being in contact with the flat outer surfaces of the rotor core. In an example preferred embodiment of the present disclosure, the rotor assembly includes a plurality of magnetic flux conductors, one magnetic flux conductor being assigned to one permanent magnet in each case, and the magnetic flux conductors each including a convex outer circumferential surface and a flat inner contact surface, the flat inner contact surface of the respective magnetic flux conductor being in contact with the flat outer contact surface of the corresponding permanent magnet, and the magnetic flux conductors each being defined by a single piece.

Preferably, the rotor assembly also includes a magnet holder, which includes a number of holding sections, each of which is between two circumferentially adjacent permanent magnets and magnetic flux conductors and which are on a base of the magnet holder, and which hold the magnetic flux conductors on the permanent magnets in the radial direction. It is preferred that the holding sections include a shaft section and a head section, the shaft sections being T-shaped in a cross-section along a plane transverse to the central axis, so that the shaft sections fix the position of the permanent magnets and magnetic flux conductors in the radial direction.

Preferably, the shaft sections are at least partially inserted into the axially extending grooves of the rotor core. It is also advantageous if the head sections engage in the recesses of the rotor core, which are located in the area of the front surface of the rotor core, and thus define a position of the magnet holder in relation to the rotor core in the axial direction.

The permanent magnets are preferably cuboidal, which makes their manufacture much easier.

Furthermore, a brushless electric motor with a stator, a motor shaft rotatably mounted in a housing, and with a rotor assembly fixed to the motor shaft as described above, is provided.

In addition, an example preferred embodiment of a method of manufacturing an internal rotor core of a brushless electric motor from a single workpiece includes providing a mold, cold extruding of a workpiece mass with a bolt into a shape and forming a rotor core including a central bore extending along a central axis.

Preferably, the mold has a negative imprint to define grooves on the outer surface of the rotor core, which extend in a radial direction from the central axis. It is also preferred if the mold has a negative imprint to define grooves at one end of the rotor core in the direction of the central axis, the grooves having a constant or substantially constant depth in the direction of the central axis and being open at the top and having an undercut in the radial direction.

In an example preferred embodiment, the mold has a negative imprint to define a pot-shaped of the rotor core. This saves material and weight of the rotor core.

The above and other elements, features, steps, characteristics and advantages of the present disclosure will become more apparent from the following detailed description of the example embodiments with reference to the attached drawings.

### BRIEF DESCRIPTION OF THE DRAWINGS

Example preferred embodiments of the present disclosure are described in more detail below with reference to the drawings. Identical components or components with identical functions bear identical reference signs.

FIG. 1 illustrates a rotor assembly in a perspective view with a rotor core according to a preferred embodiment of present invention.

FIG. 2 is a perspective view of the rotor core.

FIG. 3 is an electric motor with the rotor assembly of FIG. 1.

### DETAILED DESCRIPTION

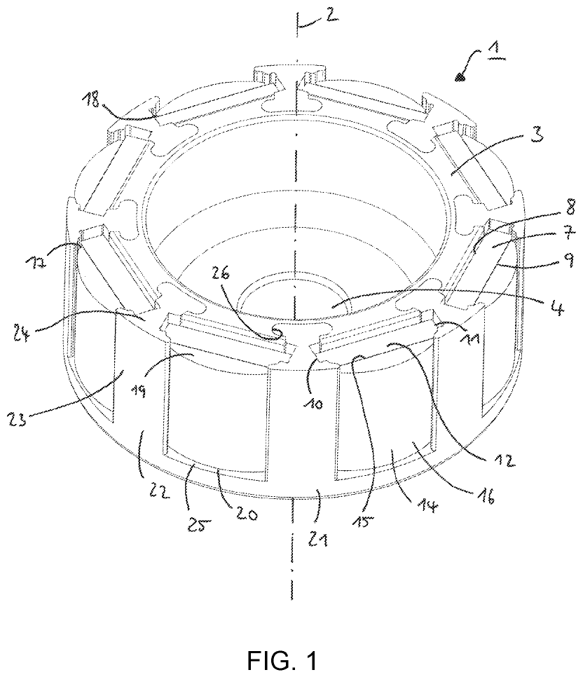

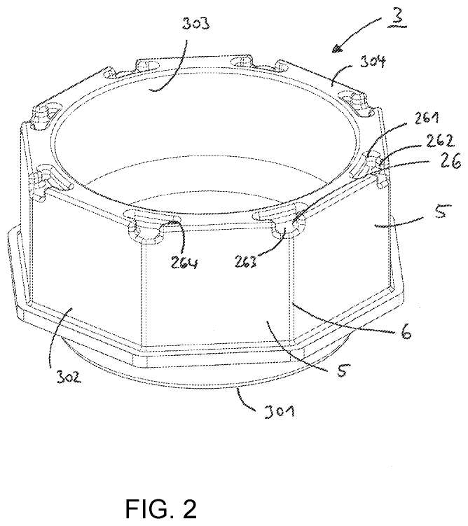

FIG. 1 shows a rotor assembly 1 with a central axis 2, which coincides with an intended axis of rotation of the rotor assembly 1. The rotor assembly 1 has an essentially rotationally symmetrical rotor core 3, which has a central bore 4 to accommodate a motor shaft not shown. The rotor core is an internal rotor core and part of a brushless electric motor designed as an internal rotor motor. FIG. 2 shows in detail the rotor core 3. The rotor core 3 has flat outer surfaces 5 on its outer side, namely in this example embodiment a total of eight outer surfaces 5, each of the same size and shape, distributed at uniform angular intervals along the outer peripheral surface of the rotor core 3. The rotor core 3 is manufactured in one piece. It therefore does not consist of several lamellas lying on top of each other, or it is not available as a layered core. It is formed from a single workpiece with a single material. Therefore no other elements forming the rotor core are molded onto it. It preferably consists of a soft steel with a high iron content and is preferably produced by cold pressing, for example C15E or a similar material. A groove 6 is provided between each two outer surfaces 5, which is formed from the outside in the radial direction into the edge formed by the two adjacent outer surfaces 5 in this area. The groove 6 is open radially outwards and runs parallel to the central axis 2. The outer surfaces 5 are abutted by a total of eight cuboid permanent magnets 7, which have a rectangular cross-section with an inner flat contact surface 8, an outer flat contact surface 9, and two flat side surfaces 10, 11. The inner contact surface 8 of the permanent magnets 7 points radially inwards towards the rotor core 3 and the outer contact surface 9 is opposite the inner contact surface and points radially outwards away from the rotor core 3. The side surfaces 10, 11 extend in radial direction, perpendicular to the contact faces 8, 9. Finally the permanent magnets 7 have axial end surfaces 12. The permanent magnets 7 are preferably made of neodymium or ferrite and are preferably manufactured in a sintering process.

At the outer contact surfaces 9 of the permanent magnets there are magnetic flux conductors 14, each of the same size and shape, distributed at uniform angular intervals along the outer peripheral surface of the rotor core 3. The magnetic flux conductors 14 each have a flat contact surface 15, a convex outer circumferential surface 16 and side surfaces 17 and 18. The flat contact surface 15 of the magnetic flux conductors points radially inwards towards the rotor core 3 and the convex outer circumferential surface 16 points radially outwards away from the rotor core 3. The side surfaces 17 and 18 of the magnetic flux conductors extend approximately in radial direction and are opposite each other in circumferential direction. Finally, the magnetic flux conductors 14 have axial end surfaces 19, 20. The magnetic flux conductors 14 lie with their flat contact surface 15 in contact with the outer contact surface 9 of the permanent magnets and extend over a range of at least 80% of the width of the outer contact surface in the circumferential direction. In axial direction the permanent magnets 7 and the magnetic flux conductors 14 preferably have the same length. The radius of convexity of the outer circumferential surface 16 of the magnetic flux conductor 14 is less than or equal to the radius of the envelope of the rotor core, in particular at least half the radius of the envelope. The magnetic flux conductors 14 are preferably made of a soft steel with a high iron content, for example C15E or a similar material. The magnetic flux conductors 14 are preferably made in one piece, i.e. they do not consist of several lamellas lying on top of each other or are not available as a layered core. They are preferably manufactured in an extrusion process and cut to their length extending in the axial direction. The side surfaces 17, 18 of the magnetic flux conductors 14 are formed by deburring the edges. The magnetic flux conductors 14 are designed to influence the magnetic fluxes generated by the permanent magnets 7. Due to the convexity of the magnetic flux conductors 14, the magnetic flux is focused in such a way that a limited area with higher flux density is formed radially outwards, extending away from the rotor core 3.

The permanent magnets 7 and magnetic flux conductors 14 are held on the rotor core 3 by means of a magnet holder 21. The magnet holder 21 is preferably made of an injection-moldable plastic, preferably polybutylene terephthalate with 30% glass fiber (PBT 30) or polyamide (PA), and is preferably produced in an injection molding process. The magnetic holder 21 has holding sections 22, each of which has a shaft section 23 and a head section 24, whereby the shaft section 23 extends into the groove 7 by means of a web and is held there with a positive fit. The shaft sections 23 of the holding sections 22 extend vertically from a ring-shaped base 25 of the magnet holder 21. The holding sections 22 are formed to the outside of the base 25. The base 25 is dimensioned in such a way that the rotor core 3, the permanent magnets 7 and the magnetic flux conductors 14 rest with their one end surface at least partially on the base. The head section 24 is molded onto the side of the shaft section 23 remote from the base and extends in the radial direction of the arrangement, from the shaft section 23 in the direction of the rotor core 3. The permanent magnets 7 and the magnetic flux conductors 14 are fixed by the holding sections 22 in the circumferential direction of the rotor assembly 1 by resting with their side surfaces against the respective adjacent shaft section 23. The permanent magnets 7 and the magnetic flux conductors 14 are also held by the shaft sections 23 in the radial direction outwards. For this purpose, the shaft sections 23 have a seat for the permanent magnets 7 and a seat for the magnetic flux conductors 14. For this purpose, the shaft sections 23 are essentially T-shaped in cross-section, with the part extending in the radial direction engaging in the groove 6 and the part extending in the circumferential direction holding the magnetic flux conductors 14 and the permanent magnets 7 in position in the radial direction. The head section 24 engages in a corresponding recess 26 of the rotor core 3, which is arranged in the region of the end surface of the rotor core 3 and thus forms a fixation of the magnet holder 21 relative to the rotor core 3 in the axial direction with the aid of the base 25 of the magnet holder 21. The head section 24 is further shaped in the radial direction in such a way that it engages in undercuts of the recess and thus additionally fixes the magnet holder 21 to the rotor core 3 in the radial direction. The permanent magnets 7 are pushed into the magnet holder 21 in the direction of the base 25. In doing so, the shaft sections 23 serve as guides. The base 25 serves as a stop in axial direction. After the permanent magnets 7 have been inserted, the magnetic flux conductors 21 are pushed in in the same direction. Here too, the shaft sections 23 serve as a guide and the base 25 as a stop. Finally, a sleeve not shown is pushed onto the rotor assembly in the direction towards the floor, covering the end surfaces of the elements 7, 14, 3 on the side facing away from the floor, thus fixing the position of the permanent magnets 7 and the magnetic flux conductors 14 in the axial direction with the help of the base 25 relative to the magnet holder 21.

The rotor core 3 is pot-shaped with a circular disc-shaped base 301 and a jacket 302, whereas the jacket 302 is cylindrical on the inside 303. The base 301 is penetrated by the central bore 4. This shape can be realized particularly precisely and economically by cold extrusion. No finishing, as is necessary when casting from steel, is required. The inner diameter of the center bore 4 is smaller than the inner diameter of the jacket 302, so the rotor core 3 is not completely filled up to the motor shaft, which makes it considerably lighter than conventional rotor cores. In addition, material can be saved, which further reduces the manufacturing costs. Due to its cup-shaped form, the rotor core 3 has a special dynamic behavior and low inertia, which is an advantage especially during load changes.

At one end of the rotor core 3 in axial direction or respectively at the end surface 304 of the jacket 302 the recesses 26 are arranged. The recesses 26 extend in a T-shape, generally in the radial direction, with the transverse portion of the recess 261 oriented in the circumferential direction and the portion 262 perpendicular thereto extending radially outwards from the transverse portion 261. The recess 26 is thus open at the top, in the axial direction, and open on one side in the radial direction, the opening 263 in the radial direction having a clear width which is smaller than the width of the recess 26 in the circumferential direction. The recess 26 thus has an undercut 264 in the radial direction. In axial direction, recess 26 has a constant depth and no undercuts. The depth of the recess 26 is preferably in a range between 0.5 mm and 1.5 mm, especially a maximum of 2 mm in axial direction. Due to the simplicity of the recess 26, it can be formed during cold extrusion of the rotor core 3. Therefore no reworking is required to form the recesses 26, which greatly simplifies the production of the rotor core 3 and reduces costs. The recesses 26 are located in the circumferential direction in the area of the edges between two adjacent outer surfaces 5. From one recess 26 at one end of the rotor core to the other end of the rotor core, a groove 6 extends along the edges between two adjacent outer surfaces 5 in the axial direction. The grooves 6 are open radially outwards and run parallel to the center axis 2. They are also formed during the forming of the rotor core 3 and do not require any finishing. The magnet holder 21 shown in FIG. 1 engages in the grooves 6 and the recesses 26 and can, in conjunction with the rotor core 3, fix the position of the permanent magnets 7 and the magnetic flux conductors 14 in the radial direction.

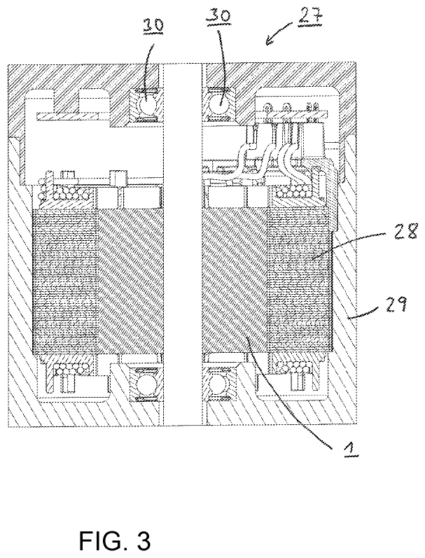

FIG. 3 shows a cross-sectional view of an electric motor 27 with rotor core 3 according to the present disclosure. The electric motor 27 comprises stator 28. Inside stator 28, rotor assembly 1 with rotor core 3 is rotatably mounted in a manner known per se. The arrangement is surrounded by a motor housing 29, which carries roller bearings 30 for the rotatable mounting of rotor assembly 1.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-13. (canceled)

14. An internal rotor core of a brushless electric motor, the internal rotor core comprising:
a central bore; wherein
the internal rotor core is made from a single unitary structure; and
the rotor core is made of a cold-extruded material.

15. The internal rotor core according to claim 14, wherein the rotor core is made of a soft steel.

16. The internal rotor core according to claim 14, wherein
the rotor core includes flat outer surfaces with a same size and shape and distributed at uniform or substantially uniform angular intervals along an outer peripheral surface of the rotor core;
between each pair of the outer surfaces a groove is provided to extend from outside in a radial direction in an edge defined by the pair of the outer surfaces.

17. The internal rotor core according to claim 16, wherein the groove is open radially outwards and extends parallel or substantially parallel to a central axis of the rotor core.

18. The internal rotor core according to claim 14, wherein recesses to receive magnet holders are at one end of the rotor core in an axial direction.

19. The internal rotor core according to claim 18, wherein the recesses are T-shaped in a radial direction and open towards a top in the axial direction.

20. The internal rotor core according to claim 14, wherein the rotor core is pot-shaped and includes a bottom through which the central bore passes, an inner diameter of the central bore being smaller than an inner diameter of the rotor core in the region of the pot.

21. A rotor assembly of a brushless electric motor, the rotor assembly comprising:
the annular inner rotor core according to claim 16 surrounding a central axis;
permanent magnets arranged around the rotor core in a circumferential direction of the rotor assembly, each of the permanent magnets including a flat outer contact surface, a flat inner contact surface, two axial end surfaces, and two side surfaces, the flat inner contact surfaces being held against the flat outer surfaces of the rotor core.

22. The rotor assembly according to claim 21, further comprising magnetic flux conductors each provided for a corresponding one of the permanent magnets; wherein
each of the magnetic flux conductors includes a convex outer circumferential surface and a planar inner contact surface;
the planar inner contact surfaces are in contact with the flat outer contact surfaces of the permanent magnets; and
the magnetic flux conductors are each defined by a single unitary structure.

23. The rotor assembly according to claim 21, further comprising:
a magnet holder including holding portions each of which is between two circumferentially adjacent permanent magnets, and magnetic flux conductors on a bottom of the magnet holder; wherein
the magnetic flux conductors contact the permanent magnets in a radial direction.

24. A brushless electric motor, comprising:
a stator;
a motor shaft rotatably supported in a housing; and
the rotor assembly according to claim 21 mounted on the motor shaft.

25. A method of manufacturing an internal rotor core of a brushless electric motor from a single workpiece, the method comprising:
providing a mold; and
cold extruding the single workpiece with a bolt into the mold and forming a rotor core which includes a central bore extending along a central axis.

26. The method according to claim 25, wherein the mold includes a negative imprint that forms recesses at one end of the rotor core in an axial direction, the recesses having a constant or substantially constant depth in the axial direction and being open at a top and including an undercut in a radial direction.
